(19) United States
(12) Patent Application Publication
(10) Pub. No.: US 2002/0150294 A1
(43) Pub. Date: Oct. 17, 2002

(54) Automated imaging system and method for concrete quality analysis

(75) Inventors: Steven P. Cave, Albuquerque, NM (US); Nelson G. Cook, McGirk, MO (US); Chris W. Baumgart, Albuquerque, NM (US); Kim D. Linder, Cedar Crest, NM (US)

Correspondence Address: HOVEY WILLIAMS TIMMONS & COLLINS, 2405 GRAND BLVD., SUITE 400, KANSAS CITY, MO, 64108

(73) Assignee: HONEYWELL FEDERAL MANUFACTURING & TECHNOLOGIES, LLC

(21) Appl. No.: 10/066,277

(22) Filed: Feb. 1, 2002

Related U.S. Application Data
(60) Provisional application No. 60/265,913, filed on Feb. 2, 2001.

(51) Int. Cl. G06K 9/34

(52) U.S. Cl. 382/173; 382/224; 382/190

(57) ABSTRACT

A system and a method using image processing and pattern recognition techniques to substantially automatically analyze a captured image in order to accurately estimate a variety of microscopical properties of a prepared sample of a material in accordance with an established standard. Where the material is Portland cement concrete and the standard is ASTM C457-90, the analysis is operable to calculate estimates of sixteen characteristics to detect voids in the concrete, while discriminating against other components and features of the concrete. The preferred system broadly comprises a microscope; a high-precision stage; an image capturing mechanism; and a computing device. Analysis techniques applied to the image include color segmentation and recognition; shape feature segmentation and analysis; and intensity profile segmentation and recognition; the results of which are integrated to provide a final result wherefrom quality of the material may be determined.

### RELATED APPLICATIONS

The present application is related to and claims priority benefit of the filing date of a provisional application titled “Imaging System for Concrete Quality Analysis”, Serial No. 60/265,913, filed Feb. 2, 2001, which is hereby incorporated into the present application by reference.

### FEDERAL SPONSORED RESEARCH/DEVELOPMENT PROGRAM

The present invention was developed with support from the U.S. government under a contract with the United States Department of Energy, Contract No. DE-ACO4-76-DP00613. Accordingly, the U.S. government has certain rights in the present invention.

### COMPUTER PROGRAM LISTING APPENDIX

A computer program listing appendix containing the source code of a computer program that may be used with the present invention is incorporated herein by reference and appended hereto as two (2) original compact disk(s), and an identical copy thereof, containing a total of four (4) files as follows:

| File name | Date of Creation | Size (Bytes) |
|---|---|---|
| C_CODE.TXT | 01/31/2002 09:57a | 168,729 |
| C_CODE_H.TXT | 01/31/2002 09:57a | 13,198 |
| VB_CODE.TXT | 01/31/2002 09:57a | 141,557 |
| VB_CODE2.TXT | 01/31/2002 09:57a | 63,070 |

### BACKGROUND OF THE INVENTION

1. FIELD OF THE INVENTION

The present invention relates broadly to systems using automated image processing and pattern recognition techniques for evaluating materials. More particularly, the present invention concerns a system and a method using image processing and pattern recognition techniques to substantially automatically analyze one or more captured images, preferably hundreds or thousands of images, of a prepared sample of a material, such as, for example, Portland cement concrete, in order to accurately estimate a variety of microscopical properties of the material and to facilitate evaluation of the quality of the material in accordance with an established standard.

2. DESCRIPTION OF THE PRIOR ART

It is often desirable to evaluate the quality of materials used in construction or manufacturing, and various methods and standards exist for doing so. It is desirable, for example, to evaluate the quality of Portland cement concrete, used to build roadways, building, bridges, and other structures, in order to ensure its suitability and continued strength. Concrete quality evaluation typically includes a determination of the number, size, distribution, and other characteristics of voids, or air spaces, that form in concrete due to entrained air. The quality evaluation process also includes a characterization of defects caused by insufficient consolidation of the concrete. Standards have been developed to facilitate such evaluation, such as, for example, the C457-90 standard, “Microscopical Determination of Parameters of the Air-Void System in Hardened Concrete”, promulgated by the Association of Standards and Testing Materials (ASTM), which defines acceptable methods for the measurement of Portland cement concrete properties.

Currently, many state highway transportation departments perform manual evaluations of concrete in order to determine, for example, the quality of newly laid concrete and the degradation of quality due to aging in previously laid concrete. Typically, a cylindrical core, approximately four to six inches in diameter, is first removed from a section of roadway or other concrete structure to be evaluated. Then a sample, approximately 1.25 inches thick, is sliced from the core, and a face of the sample is polished. The sample is then placed on a linear traverse and illuminated with a light source. The light source is positioned to illuminate the polished surface of the sample at a grazing angle, thereby producing strong shadows within any voids and brightly illuminating the edges of the voids opposite the light source, which enhances surface contrast and facilitates identifying the voids.

The illuminated sample is viewed by a technician through a microscope. The technician visually scans the sample by linearly traversing the polished face and identifying components (e.g., void, aggregate, sand, or paste, or crack, gap, or fissure) along a single scan line. The length of the chord traversing each distinct component is recorded. Typically, 7 to 10 such scans are performed along regularly selected lines, with as many as 500 chords per scan line.

After completion of the scanning process, the measured chord lengths are used to calculate estimates of properties specified in the applicable standard. In a preferred embodiment, for example, sixteen microscopical properties of the concrete are computed from manually measured and characterized components along the scan lines. One of the most critical properties is the percentage of each scan line crossing an observed void. Additionally, a distribution of void diameters is statistically computed based on the measurement of chord lengths across each detected void.

It will be appreciated that such a manual process can be extremely tedious, time-consuming, and inefficient, and typically requires between approximately eight and twelve hours per sample to complete. Furthermore, because of its reliance on human senses, the analysis may lack a high level of precision and, as a result, lack repeatability. For example, light gray aggregate and sand are very similar in color to paste, which can result in erroneous classifications. Similarly, a sand crystal can sometimes be mistaken for a void, resulting in an erroneously large number of voids being reported relative to the percentage of paste or aggregate. Also, a large number of pathologies may be encountered during evaluation, including, for example, gaps, cracks, fissures, merged or overlapping voids, and voids filled with material such as ettringite, the misidentification of which can substantially affect the evaluation results.

Additionally, an alternative method used in the prior art is surface, or depth, profiling. A primary disadvantage of this approach, however, is the relatively high cost of the equipment needed to implement this technique.

Additionally, a great deal of critical knowledge and experience needed to perform such manual evaluations resides with a relatively small number of experts currently performing the manual process. This expertise is generally unavailable for wider use and dissemination or for use in training others.

Due to the above-identified and other problems and disadvantages in the art, a need exists for an improved system and method for concrete analysis which is more efficient and which provides more consistent results than existing means.

### SUMMARY OF THE INVENTION

The present invention overcomes the above-described and other problems and disadvantages in the prior art to provide a distinct advance in the art of systems and methods using automated image processing and pattern recognition techniques for evaluating materials. More particularly, the present invention provides a system operable to use image processing and pattern recognition techniques to substantially automatically analyze one or more captured images of a prepared sample of a material in order to accurately estimate a variety of microscopical properties of the material in accordance with an established standard. The system combines image acquisition, image analysis, and report generation to substantially mimic the above-described manual process while providing a substantially higher degree of repeatability and efficiency.

As described herein, an example of the material to be evaluated using the present invention is Portland cement concrete, as is commonly used in the construction of roads, buildings, and similar structures. It will be appreciated by those in the construction industry that concrete includes a variety of components and features, including, for example, a number of voids resulting from entrained air, the presence and characteristics of which can affect the concrete's durability. Thus, the system and method of the present invention are described herein as being operable to calculate estimates of sixteen measurements which include all requirements of ASTM standard C457-90, to detect voids in the concrete while discriminating against other features and components. It should be noted, however, that the present invention is readily adaptable for use in evaluating a variety of materials using a variety of appropriate standards, and is in no way limited to evaluating only concrete or to using only the ASTM standard.

In a preferred embodiment, the system broadly comprises a microscope; a high-precision stage; an image capturing mechanism; and a computing device. The microscope is operable to provide an illuminated, greatly magnified view of the sample. The stage is operable to move and position the sample under the microscope for viewing. The image capturing mechanism is coupled with the microscope and is operable to capture one or more images of the provided view. The computing device is coupled with the microscope, the stage, and the image capturing mechanism, and is operable to store and execute a computer program operable to control the evaluation process. The stage, for example, is controlled by the computing device to achieve precise movements so as to preclude overlapping adjacent fields-of-view.

In use and operation, a cylindrical core of approximately four to six inches in diameter is cut from the section of road or other concrete structure to be analyzed. The sample, approximately 1.25 inches thick, is removed from the core and polished. The sample is then placed on the stage, and the system is initialized and set-up. A graphical user interface facilitates convenient and efficient user interface with the computer program, particularly with regard to setup, initiation, and control of scanning, image capture, and image analysis; however, human interaction is minimized throughout the process. Thus, for example, focusing and lighting levels at the microscope are preferably automatically controlled by the computing device. The sample is illuminated at a grazing angle, which accentuates voids and improves contrast for the scanning process. The sample is then surface scanned using a surface imaging technique to capture the one or more images, preferably hundreds or thousands of images.

The captured images are then automatically analyzed by the computer program to extract key characteristics and properties of the sample which are relevant to determining the quality of the concrete. Broadly, the computer program uses image enhancement and segmentation and pattern recognition techniques to extract salient information from the images, including, for example, percent void; voids per inch; spacing factor; average void size; and distribution of void sizes.

It will be appreciated that the present invention provides a number of distinct advantages over the prior art, including reduction or elimination of tedious and inefficient aspects of the manual evaluation process, resulting in, among other things, improved uniformity and efficiency in the evaluation process.

Furthermore, use of the surface imaging technique, rather than the prior art surface profiling technique, results in an efficiently minimized number of scans and advantageously allows for effective measurement of void diameters using substantially less expensive equipment (in 2002, approximately $5,000-$10,000 for surface imaging versus approximately $100,000 for surface profiling).

Additionally, the image analysis technique of the present invention is extremely flexible and extensible, thereby allowing it to accommodate the inevitable pathologies that are encountered during the analysis process, including, for example, cracks, gaps, and fissures, voids filled with material such as ettringite, and overlapping voids.

Additionally, the present invention advantageously incorporates critical expertise of the scanning process from a relatively small number of experts in concrete analysis who currently perform the prior art manual process, thereby substantially automating the application of their knowledge and making it more widely available. Thus, the knowledge is captured, preserved, and made available for training others.

Potential applications for the present invention include use by state transportation departments' physical analysis laboratories for providing concrete evaluation services. The present invention also has application in use by commercial companies within the concrete and construction industries for evaluating the quality and durability of their product.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a system diagram of a preferred embodiment of a system of the present invention;

FIG. 2 is a plan view of a magnified and illuminated prepared sample of concrete; and

FIG. 3 is a flowchart of preferred method steps performed in using the system of FIG. 1.

### DETAILED DESCRIPTION OF A PREFERRED EMBODIMENT

Referring to the figures, a system 10 is shown constructed in accordance with a preferred embodiment of the present invention. The system 10 is operable to use image processing and pattern recognition techniques to substantially automatically analyze one or more captured images of a prepared sample 12 of material in order to accurately estimate a variety of microscopical properties of the sample 12 in accordance with an established standard.

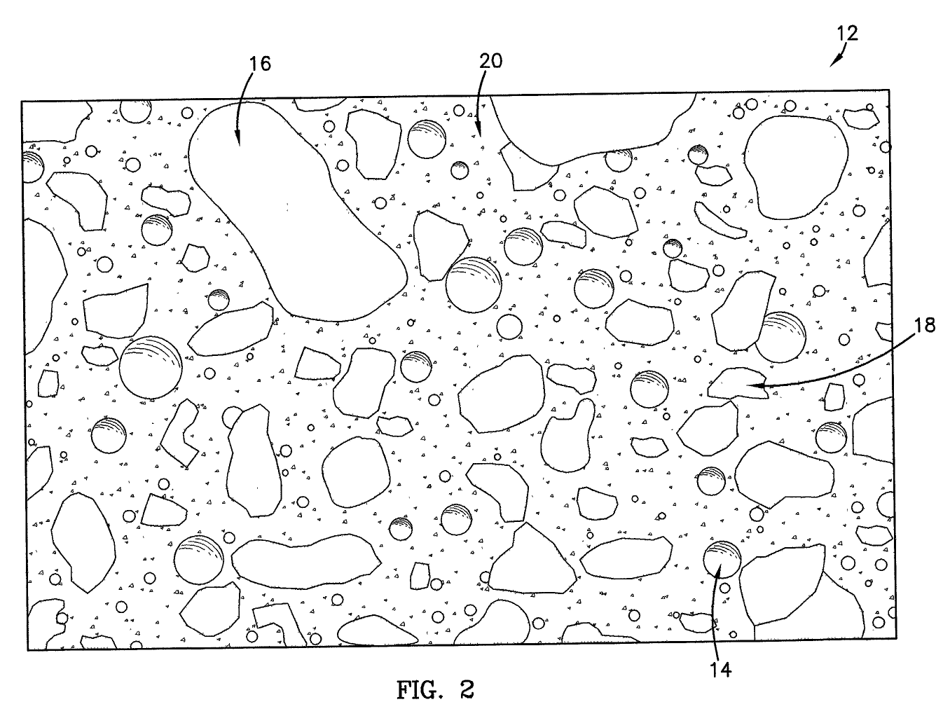

Referring particularly to FIG. 2, as described herein the material 12 to be evaluated is Portland cement concrete, as is commonly used in the construction of roads, buildings, and similar structures. It will be appreciated by those in the construction industry that concrete includes a variety of components, including, for example, a number of voids 14, a percentage of aggregate 16, a percentage of sand 18, and a percentage of paste 20, and features, such as, for example, gaps, fissures, cracks, overlapping voids, and voids filled with material such as ettringite. The voids 14 are air spaces resulting from entrained or entrapped air, and while a certain number of voids having specific maximum diameters and other characteristic are acceptable, too many or too large voids may adversely affect the quality of the concrete.

A commonly used standard for evaluating concrete is the C457-90 standard, “Microscopical Determination of Parameters of the Air-Void System in Hardened Concrete”, promulgated by the American Society of Testing and Materials (ASTM). As described herein, the system 10 is operable to calculate estimates of sixteen characteristics to detect voids 14 in the sample 12. In doing so, the system 10 is operable to discriminate between voids 14 and aggregate 16, sand 18, paste 20, and other features such as cracks, gaps, and fissures. The relative percentage of sample volume occupied by voids 14 compared to other components and features of the sample 12 is used as a measure of the quality of the concrete. It should be noted, that the present invention is readily adaptable for use in evaluating a variety of materials using a variety of appropriate standards, and is in no way limited to evaluating only concrete or to using only the ASTM standard.

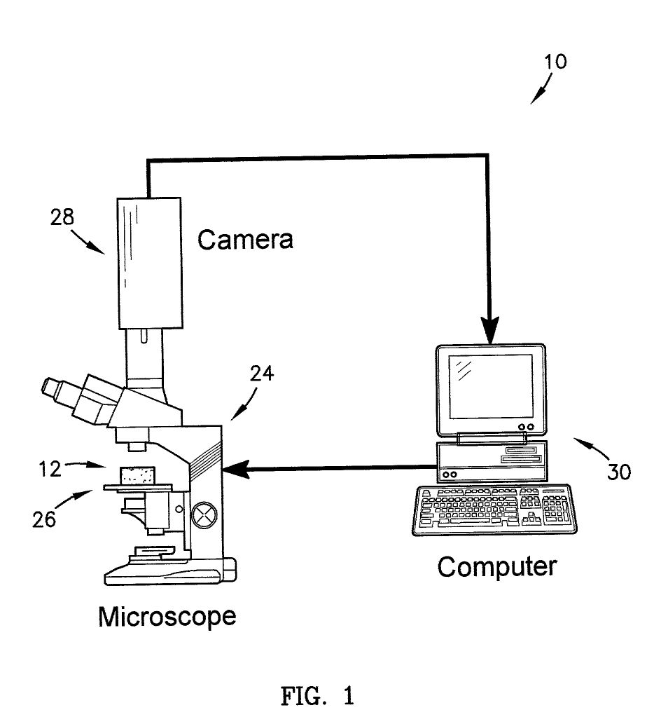

As illustrated, referring particularly to FIG. 1, the system 10 broadly comprises a microscope 24; a high-precision stage 26; an image capturing mechanism 28; and a computing device 30. The microscope 24 is operable to provide an illuminated and greatly magnified view of the prepared sample 12. In one embodiment, the microscope 24 is a substantially conventional research-grade compound microscope, such as, for example, a Leica MZ12 having a plan-APO lens, an HU tube or trinocular configuration, and Volpi lighting.

The high-precision stage 26 is operable to move and position the sample 12 under the microscope 24 for viewing. The stage 26 is controlled by the computing device 30, thereby achieving a high level of precision so as to preclude overlapping adjacent fields-of-view. In one embodiment the stage 26 is a conventional high-precision two-dimensional or x-y stage, such as is currently available, for example, from Aerotech.

The image capturing mechanism 28 is coupled with the microscope 24, and is operable to capture the one or more images of the view provided by the microscope 24. In one embodiment, the image capturing device 28 is a substantially conventional CCD camera, such as, for example, a three RGB color CCD Sony XC-003 video camera having a resolution of approximately 1.129 microns/pixel at 100×, and 9.3 microns/pixel at 12.5×. This allows detection of features as small as two microns in extent within an acquired image.

The computing device 30 is coupled with the microscope 24, the stage 26, and the image capturing mechanism 28, and is operable to store and execute a computer program operable to control the evaluation process generally. In one embodiment, the computing device 30 is a substantially conventional personal computer equipped with a video frame grabber, such as, for example, 450 MHz dual Pentium personal computer equipped with a Matrox Corona video frame grabber for acquisition of 748×484 pixel images.

The aforementioned computer program is operable to implement and control the evaluation process, including controlling operation of the microscope 24, the stage 26, and the image capturing mechanism 28; receiving the captured images from the image capturing mechanism 28 and performing an analysis on the images; and generating a report setting forth the results of the analysis. In order to facilitate such control and implementation, the computer program generates a graphical user interface (GUI) with which a user may conveniently setup, initiate, and control the various processes associated with the evaluation. These processes are described below in greater detail.

A preferred embodiment of the computer program is appended hereto for illustrative purposes only, as it is considered within the ability of one with ordinary skill in the art to create such a program given the description set forth herein of the functionality of the present invention. Broadly, the computer program comprises a combination of code segments that may be written in any suitable programming language, such as, for example, Java or C++, and stored in or on any suitable computer-readable memory medium, such as, for example, a hard drive or compact disk, and executed by the computing device 30.

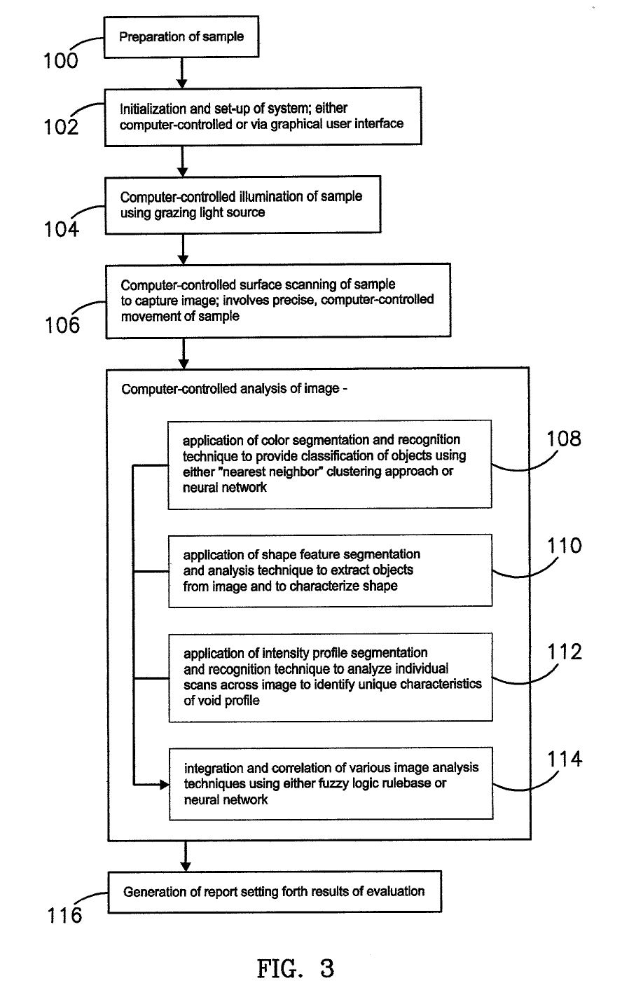

In use and operation, referring particularly to FIG. 3, the evaluation process proceeds as follows. First, the sample 12 must be prepared, as depicted by box 100. This involves cutting a cylindrical core, approximately four to six inches in diameter, from the section of road or other concrete structure to be analyzed. A sample 12, approximately 1.25 inches thick is removed from the core and polished. The sample 12 will appear under the microscope 24 substantially similar to FIG. 1.

Next, the sample 12 is placed on the stage 28, and the system 10 is initialized and set-up, as depicted by box 102. The graphical user interface facilitates convenient and efficient user interface with the computer program, particularly with regard to setup, initiation, and control of scanning, image capture, and image analysis. Human interaction is minimized throughout the process. Thus, for example, focusing and lighting levels are preferably automatically controlled by the computing device 30.

The sample 12 is illuminated with a light source at a grazing angle, as depicted by box 104, which accentuates voids and improves surface contrast by producing strong shadows within the voids 14 while brightly illuminating the edges of the voids 14 opposite the light source. Such illumination facilitates the scanning process and the identification of objects, whether components or features of the sample, in the images.

The sample 12 is then automatically surface scanned at both a high and a low magnification, and one or more images, preferably hundreds or thousands of images, are captured as the stage 28 moves the sample 12 through the field-of-view, as depicted by box 106. As mentioned, surface imaging efficiently allows for the generation of a multitude of profiles with each captured image, and also advantageously allows for effective measurement of void chords. Because the stage 28 is controlled by the computing device 30, the scanning is performed at a high level of precision to preclude overlap of adjacent fields-of-view.

The captured images are then analyzed by the computer program to extract key characteristics and properties of the sample 12 which are relevant in determining the quality of the concrete, as depicted by boxes 108, 110, 112, 114. Broadly, the computer program uses image enhancement and segmentation and pattern recognition techniques to extract salient information from the images and to identify and characterize voids 14. This requires differentiating voids 14 from other components and features of the sample. Both the relative percentage of voids 14 and the distribution of void diameters are used in calculating sixteen different microscopic properties of the sample, including, for example, percent void; voids per inch; spacing factor; average void size; and distribution of void sizes.

In one embodiment, three different segmentation and recognition techniques are applied to each image to extract and identify voids 14 and other objects. These techniques include color segmentation and recognition (box 108); shape segmentation and recognition (morphological processing) (box 110); and intensity profile segmentation and recognition (box 112). In each case, the object extracted from the image is characterized with a set of features or characteristics, such as, for example, color, shape, intensity, and associated features in the local area, which are used to uniquely discriminate among objects, including discriminating voids 14 from other components 16, 18, 20 and features of the concrete.

The color segmentation and recognition technique is operable to provide a classification of the objects based on a “nearest neighbor” clustering approach, thereby facilitating differentiation between the various components and features. This technique may use three color processing, or may additionally or alternatively use other color planes, such as hue or saturation, to enhance segmentation and recognition. As an alternative to the nearest neighbor approach, a neural network may be trained to perform component classification.

The shape feature segmentation and analysis technique is operable to extract objects from the captured imagery and to characterize their shape. With regard to voids 14, for example, this is accomplished by correlating bright areas of voids with dark regions of voids, and uses a fuzzy logic correlator.

The intensity profile segmentation and recognition technique is operable to analyze individual scans across the images to identify unique characteristics of the void profile.

All classification information from the various image analysis techniques is integrated (box 114), including results from both the low magnification scans and the high magnification scans. Such integration is accomplished using a fuzzy logic rulebase or a neural network. Then the extracted features are input into a fuzzy logic inferencing procedure that correlates all extracted information and identifies which of the detected objects are actually voids 14 and which are other concrete components (e.g., sand 16, aggregate 18, paste 20) or debris (e.g., cracks, reinforcing material). The chord length of the identified void 14 is then archived for later use in calculating estimates of the microscopic properties of the sample 12 as a whole.

As mentioned, the microscopic properties of interest will depend on the particular standard used, but may include, for example, percent void; voids per inch; spacing factor; average void size; and distribution of void sizes.

Finally, a report setting forth results of the evaluation may be generated from the graphical user interface and reported using a pre-defined report format, as depicted by box 116.

It will be appreciated that the present invention provides a number of distinct advantages over the prior art, including reduction or elimination of tedious and inefficient aspects of manual evaluation process, resulting in, among other things, improved precision and efficiency in the evaluation process.

Furthermore, the use of the surface imaging technique, rather than the prior art surface profiling technique, and advantageously allows for effective measurement of void diameters using substantially less expensive equipment (in 2002, approximately $5,000-$10,000 for surface imaging versus approximately $100,000 for surface profiling).

Additionally, the image analysis technique of the present invention is extremely flexible and extensible, thereby allowing it to accommodate the inevitable pathologies encountered during the evaluation process. Such pathologies include, for example, cracks, gaps, and fissures in the sample; voids filled with material such as ettringite; and overlapping voids.

Additionally, the present invention advantageously incorporates critical expertise of the scanning process from a relatively small number of experts in the filed of concrete analysis who currently perform the prior art manual process, thereby substantially automating the application of their knowledge and making it more widely available. Thus, the knowledge is captured, preserved, and made available for training others.

Potential applications for the present invention include use by state transportation departments' physical analysis laboratories for providing concrete evaluation services. The present invention also has application in use by commercial companies within the concrete and construction industries for evaluating the quality and durability of their product.

From the preceding description, it can be appreciated that present invention provides a system and a method operable to use image processing and pattern recognition techniques to substantially automatically analyze one or more captured images in order to accurately estimate a variety of microscopical properties of a prepared sample of a material in accordance with an established standard.

Although the invention has been described with reference to the preferred embodiments illustrated in the attached drawings, it is noted that equivalents may be employed and substitutions made herein without departing from the scope of the invention as recited in the claims. For example, as mentioned, though described herein in terms of evaluating concrete, the present invention is readily adaptable for use in evaluating a wide variety of materials in accordance with a variety of standards. Thus, the present invention, being broadly concerned with evaluation of material using imaging, intensity profiling, and pattern recognition, has application in a variety of fields, including, for example, the field of medicine, wherein the present invention may be used in evaluating material prepared on a microscope slide, or in the field of military defense, wherein the present invention may be used in evaluating qualities (e.g. surface pitting, microcracks) of stockpiled weapons.

Having thus described the preferred embodiment of the invention, what is claimed as new and desired to be protected by Letters Patent includes the following:

1. A system operable to substantially automatically perform an evaluation of a sample of a material according to an established standard, wherein the system comprises:
a microscope operable to magnify the sample;
a light source operable to illuminate the sample, wherein the illumination is provided at a grazing angle so as to enhance surface contrast of the sample;
a stage associated with the microscope and operable to move and position the sample under the microscope for viewing;
an image capturing mechanism operable to capture an image of the sample through the microscope; and
a computing device operable to control magnification by the microscope, control illumination by the light source, receive images from the image capturing device, control movement of the stage, and store and execute a computer program operable to substantially automatically conduct an analysis of the image and to generate a report setting forth a result of the analysis.

2. The system as set forth in claim 1, wherein the analysis includes identification and measurement of one or more components of the sample.

3. The system as set forth in claim 1, wherein the analysis includes identification and measurement of one or more physical features of the sample.

4. The system as set forth in claim 1, wherein the sample is prepared prior to being magnified by the microscope, wherein such preparation facilitates the analysis.

5. The system as set forth in claim 1, wherein the material is concrete and the sample is prepared in accordance with the established standard prior to being magnified by the microscope, wherein such preparation includes polishing a face of the sample, and the analysis includes identifying and measuring a number of voids in the sample.

6. The system as set forth in claim 1, wherein the image capturing mechanism is a CCD camera.

7. The system as set forth in claim 1, wherein the stage is a high-precision two-dimensional stage controlled by the computing device to avoid overlapping fields-of-view.

8. The system as set forth in claim 1, wherein the computer program provides a graphical user interface operable to facilitate a user setting up and initiating the analysis, and to facilitate the user causing the report to be generated.

9. The system as set forth in claim 1, wherein the computer program performs a number of different image analysis techniques on the image, including—
a color segmentation and recognition technique operable to facilitate identification and classification of an object in the image, and to differentiate the object from other objects in the image;
a shape feature segmentation and analysis technique operable to extract the object from the image and to characterize a shape of the object; and
a intensity profile segmentation and recognition technique operable to identify a unique characteristic of a profile of the object.

10. The system as set forth in claim 9, wherein the color segmentation and recognition technique is based on one or more color planes selected from the group consisting of: three color RGB, hue, and saturation.

11. The system as set forth in claim 9, wherein the color segmentation and recognition technique uses a nearest neighbor technique to identify and classify the object.

12. The system as set forth in claim 9, wherein the color segmentation and recognition technique uses a neural network and an associated rulebase to identify and classify the object.

13. The system as set forth in claim 9, wherein the object is a void and the shape feature segmentation and analysis technique is operable to extract the void from the image and to characterize the shape of the void by correlating a bright area of the void with a dark region of the void using a fuzzy logic correlator, wherein the bright area and the dark region are enhanced by the grazing angle of the illumination.

14. A system operable to substantially automatically perform an evaluation of a prepared sample of a material according to an established standard, wherein the system comprises:
a microscope operable to magnify the prepared sample;
a light source operable to illuminate the prepared sample, wherein the illumination is provided at a grazing angle so as to enhance surface contrast of the sample;
a high-precision two-dimensional stage associated with the microscope and operable to move and position the prepared sample under the microscope for viewing;
a CCD camera operable to capture an image of the prepared sample through the microscope; and
a computing device operable to control magnification by the microscope, control illumination by the light source, receive images from the image capturing device, control movement of the high-precision of the two-dimensional stage so as to avoid overlapping fields-of-view, and store and execute a computer program operable to substantially automatically conduct an analysis of the image, wherein the analysis includes—
a color segmentation and recognition technique operable to facilitate identification and classification of an object in the image, and to differentiate the object from other objects in the image,
a shape feature segmentation and analysis technique operable to extract the object from the image and to characterize a shape of the object, and
a intensity profile segmentation and recognition technique operable to identify a unique characteristic of a profile of the object.

15. The system as set forth in claim 14, wherein the analysis includes identification and measurement of one or more components of the sample.

16. The system as set forth in claim 14, wherein the analysis includes identification and measurement of one or more physical features of the sample.

17. The system as set forth in claim 14, wherein the material is concrete and the sample is prepared in accordance with the established standard prior to being magnified by the microscope, wherein such preparation includes polishing a face of the sample, and the analysis includes identifying and measuring a number of voids in the sample.

18. The system as set forth in claim 14, wherein the computer program provides a graphical user interface operable to facilitate a user setting up and initiating the analysis, and to facilitate the user causing the report to be generated.

19. The system as set forth in claim 14, wherein the color segmentation and recognition technique is based on one or more color planes selected from the group consisting of: three color RGB, hue, and saturation.

20. The system as set forth in claim 14, wherein the color segmentation and recognition technique uses a nearest neighbor technique to identify and classify the object.

21. The system as set forth in claim 14, wherein the color segmentation and recognition technique uses a neural network and an associated rulebase to identify and classify the object.

22. The system as set forth in claim 14, wherein the object is a void and the shape feature segmentation and analysis technique is operable to extract the void from the image and to characterize the shape of the void by correlating a bright area of the void with a dark region of the void using a fuzzy logic correlator, wherein the bright area and the dark region are enhanced by the grazing angle of the illumination.

23. A method of substantially automatically performing an evaluation of a sample of a material according to an established standard, wherein the method comprises the steps of:
(a) magnifying and illuminating the sample, wherein the illumination is provided at a grazing angle so as to enhance surface contrast of the sample;
(b) capturing an image of the magnified and illuminated sample;
(c) controlling magnification and illumination of the sample and capturing of the image substantially automatically, using a computing device; and
(d) performing an analysis of the image substantially automatically, using a computing device, to allow for the evaluation of the sample in accordance with the established standard.

24. The method as set forth in claim 23, wherein the analysis in step (d) includes identification of one or more components of the sample.

25. The method as set forth in claim 23, wherein the analysis in step (d) includes identification of one or more physical features of the sample.

26. The method as set forth in claim 23, further including step (e) preparing the sample prior to performing step (a) so as to facilitate the analysis.

27. The method as set forth in claim 26, wherein the material is concrete and the preparation in step (e) includes polishing a face of the sample, and the analysis in step (d) includes identifying and measuring any voids in the sample.

28. The method as set forth in claim 23, wherein step (c) includes moving the sample in a precise computer-controlled manner so as to avoid overlapping fields-of-view.

29. The method as set forth in claim 23, wherein the analysis in step (d) includes—
(d₁) facilitating identification and classification of an object in the image and differentiating the object from other objects in the image using a color segmentation and recognition technique;
(d₂) extracting the object from the image and characterizing a shape of the object using a shape feature segmentation and analysis technique; and
(d₃) analyzing individual scans across the image to identify a unique characteristic of a profile of the object using a intensity profile segmentation and recognition technique.

30. The method as set forth in claim 29, wherein the color segmentation and recognition technique in step (d₁) is based on one or more color planes selected from the group consisting of: three color RGB, hue, and saturation.

31. The system as set forth in claim 29, wherein the color segmentation and recognition technique in step (d₁) uses a nearest neighbor technique to identify and classify the object.

32. The system as set forth in claim 29, wherein the color segmentation and recognition technique in step (d₁) uses a neural network and an associated rulebase to identify and classify the object.

33. The system as set forth in claim 29, wherein the object is a void and the shape feature segmentation and analysis technique in step (d₂) is operable to extract the void from the image and to characterize the shape of the void by correlating a bright area of the void with a dark region of the void using a fuzzy logic correlator, wherein the bright area and the dark region are a result of the grazing angle of the illumination.

34. A method of substantially automatically performing an evaluation of a sample of a material according to an established standard, wherein the method comprises the steps of:
(a) preparing the sample in a manner consistent with the established standard in order to facilitate analyzing the sample;
(b) magnifying and illuminating the sample, wherein the illumination is provided at a grazing angle so as to enhance surface contrast of the sample;
(c) capturing an image of the magnified and illuminated sample;
(d) controlling magnification and illumination of the sample and capturing of the image substantially automatically, using a computing device; and
(e) performing an analysis of the image substantially automatically, using a computing device, to allow for the evaluation of the sample in accordance with the established standard, wherein the analysis includes—
(e₁) facilitating identification and classification of an object in the image and differentiating the object from other objects in the image using a color segmentation and recognition technique,
(e₂) extracting the object from the image and characterizing a shape of the object using a shape feature segmentation and analysis technique, and
(e₃) analyzing individual scans across the image to identify a unique characteristic of a profile of the object using a intensity profile segmentation and recognition technique.

35. The method as set forth in claim 34, wherein the analysis in step (e) includes identification of one or more components of the sample.

36. The method as set forth in claim 34, wherein the analysis in step (e) includes identification of one or more physical features of the sample.

37. The method as set forth in claim 34, wherein the material is concrete and the preparation in step (a) includes polishing a face of the sample, and the analysis in step (e) includes identifying and measuring any voids in the sample.

38. The method as set forth in claim 34, wherein step (d) includes moving the sample in a precise computer-controlled manner so as to avoid overlapping fields-of-view.

39. The method as set forth in claim 34, wherein the color segmentation and recognition technique in step (e₁) is based on one or more color planes selected from the group consisting of: three color RGB, hue, and saturation.

40. The system as set forth in claim 34, wherein the color segmentation and recognition technique in step (e₁) uses a nearest neighbor technique to identify and classify the object.

41. The system as set forth in claim 34, wherein the color segmentation and recognition technique in step (e₁) uses a neural network and an associated rulebase to identify and classify the object.

42. The system as set forth in claim 34, wherein the object is a void and the shape feature segmentation and analysis technique in step (e₂) is operable to extract the void from the image and to characterize the shape of the void by correlating a bright area of the void with a dark region of the void using a fuzzy logic correlator, wherein the bright area and the dark region are a result of the grazing angle of the illumination.
